(19) United States
(12) Patent Application Publication
(10) Pub. No.: US 2008/0097757 A1
(43) Pub. Date: Apr. 24, 2008

(54) Audio coding

(75) Inventor: Adriana Vasilache, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/586,350

(22) Filed: Oct. 24, 2006

(51) Int. Cl. G10L 19/02

(52) U.S. Cl. 704/229

(57) ABSTRACT

Quantized audio data may be represented by a codevector that is associated to a point of an outer shell of a rectangular truncated lattice. For indexing this codevector, number and positions of non-zero components of the codevector are determined. Moreover, signs of the non-zero components are determined. An index is then calculated by combining at least a term representing determined number and positions of non-zero components and a term representing determined signs of non-zero components. For converting the index into a codevector again, separate information on number and positions of non-zero components of a codevector and on signs of components of this codevector are extracted from the index again. The codevector is then assembled such that it complies with the extracted information on number and positions of the non-zero components and on signs of the non-zero components.

### FIELD OF THE INVENTION

The invention relates in general to the field of audio encoding and decoding.

### BACKGROUND OF THE INVENTION

For audio coding, different coding schemes have been applied in the past. One of these coding schemes applies a psychoacoustical encoding. With these coding schemes, spectral properties of input audio signals are used to reduce redundancy as well as irrelevancy. Spectral components of the input audio signals are analyzed and spectral components are removed which apparently are not recognized by the human ear. In order to apply these coding schemes, spectral coefficients of input audio signals are obtained.

Quantization of the spectral coefficients within psychoacoustical encoding, such as Advanced Audio Coder (AAC) and MPEG audio, was previously performed using scalar quantization followed by entropy coding of the scale factors and of the scaled spectral coefficients. The entropy coding was performed as differential encoding using eleven possible fixed Huffman trees for the spectral coefficients and one tree for the scale factors.

The ideal coding scenario produces a compressed version of the original signal, which results in the decoding process in a signal that is very close (at least in a perceptual sense) to the original, while having a high compression ratio and a compression algorithm that is not too complex.

### SUMMARY

The invention proceeds from the consideration that audio data may be quantized using a lattice quantizer. In this case, the quantized audio data takes the form of codevectors, which are associated to a respective point of a lattice. The codevectors may then be represented by a respective index.

For the indexing, a base representation indexing approach could be employed, which assigns to each component of a codevector a value using an increasing power of a base as a multiplier, and which sums the values for obtaining the index.

Such an approach may not provide a desired resilience to errors, like resilience to bit errors on a noisy transmission channel, though. Resilience to errors can be achieved by assigning indices that are close in a Hamming distance sense, that is, that are the same save a very few number of bits, to codevectors that are close in a Euclidean distance sense.

According to a first aspect of the invention, a method is proposed, which comprises determining number and positions of non-zero components of a codevector. The codevector is assumed to be associated to a point of an outer shell of a rectangular truncated lattice and to represent quantized audio data. The method further comprises determining signs of the non-zero components in the codevector. The method further comprises calculating an index for the codevector by combining at least a term representing said determined number of non-zero components, a term representing determined positions of non-zero components and a term representing determined signs of non-zero components.

According to the first aspect of the invention, moreover an apparatus is proposed, which comprises an indexation component. The indexation component is configured to determine number and positions of non-zero components of a codevector. The codevector is assumed again to be associated to a point of an outer shell of a rectangular truncated lattice and to represent quantized audio data. The indexation component is further configured to determine signs of the non-zero components of the codevector. The indexation component is further configured to calculate an index for the codevector by combining at least a term representing said determined number of non-zero components, a term representing determined positions of non-zero components and a term representing determined signs of non-zero components.

The apparatus could be for example an audio encoder or an entity comprising an audio encoder.

It is to be noted that the indexation component and other optional components of the apparatus can be implemented in hardware and/or in software. If implemented in hardware, the apparatus could be for instance a chip or chipset, like an integrated circuit. If implemented in software, the components could be modules of a software program code. In this case, the apparatus could be for instance a memory storing the software program code.

According to the first aspect of the invention, moreover an electronic device is proposed, which comprises the apparatus proposed for the first aspect of the invention and in addition an audio input component. Such an audio input component could be any component enabling an input of analog or digital audio data, including but not limited to a microphone, an interface to a separate memory device and an interface to another device sending audio data. The electronic device can be any kind of electronic device in which an indexing of the indicated kind of codevectors is required, including but not limited to terminals for a cellular or other wireless network and network elements of a cellular or other wireless network.

According to the first aspect of the invention, moreover a computer program product is proposed, in which a program code is stored in a computer readable medium. The program code realizes the method proposed for the first aspect of the invention when executed by a processor.

The computer program product could be for example a separate memory device, or a memory that is to be integrated in an electronic device.

The invention is to be understood to cover such a computer program code also independently from a computer program product and a computer readable medium.

According to a second aspect of the invention, a method is proposed, which comprises extracting from an index separate information on number and positions of non-zero components of a codevector and on signs of components of this codevector. The codevector is assumed again to be associated to a point of an outer shell of a rectangular truncated lattice and to represent quantized audio data. This method further comprises assembling a codevector complying with this extracted information on number and positions of the non-zero components and on signs of the non-zero components.

According to the second aspect of the invention, moreover an apparatus is proposed, which comprises an inverse indexation component. The inverse indexation component is configured to extract from an index separate information on number and positions of non-zero components of a codevector and on signs of components of this codevector. The codevector is assumed again to be associated to a point of an outer shell of a rectangular truncated lattice and to represent quantized audio data. The inverse indexation component is further configured to assemble a codevector complying with the extracted information on number and positions of the non-zero components and on signs of the non-zero components.

The apparatus could be for example an audio decoder or an entity comprising an audio decoder.

It is to be noted that also the inverse indexation component and optional other components of the apparatus proposed for the second aspect of the invention can be implemented in hardware and/or in software. If implemented in hardware, the apparatus could be for instance a chip or chipset, like an integrated circuit. If implemented in software, the components could be modules of a software program code. In this case, the apparatus could be for instance a memory storing the software program code.

According to the second aspect of the invention, moreover an electronic device is proposed, which comprises the apparatus proposed for the second aspect of the invention and in addition an audio output component. Such an audio output component could be any component enabling an output of analog or digital audio data, including but not limited to a loudspeaker, an interface to a separate memory device and an interface to another device to which audio data may be transmitted. The electronic device can be any kind of electronic device in which an inverse indexing is required which is complementary to the proposed indexing, including but not limited to terminals for a cellular or other wireless network and network elements of a cellular or other wireless network.

Moreover, a computer program product is proposed, in which a program code is stored in a computer readable medium. The program code realizes the method proposed for the second aspect of the invention when executed by a processor.

The computer program product could be for example a separate memory device, or a memory that is to be integrated in an electronic device.

The invention is to be understood to cover such a computer program code also independently from a computer program product and a computer readable medium.

Finally, a system is proposed, which comprises an apparatus proposed for the first aspect of the invention and in addition an apparatus proposed for the second aspect of the invention.

According to the invention, the most sensitive bits, namely the sign bits, are included as separable information in the index.

This decreases the effect of channel errors on transmitted indices and thus improves the quality of an output audio signal that may be obtained from the assembled codevectors.

In addition to separating the sign bits, it is also possible to separate the information relating to other characteristics of the codevector. The border, within the index, between the different information could be selected flexibly, in order to preserve the bitrate efficiency.

Such additional separated information may include in particular number and positions of non-zero components, but equally various other information.

In one embodiment of the first aspect of the invention, for example, a number of the non-zero components in the codevector and a number of maximum valued components, in absolute values, in the codevector could be determined. It is to be understood that in this case, the number of non-zero components may include or exclude the number of maximum valued components. Further, determining positions of the non-zero components in the codevector may comprise determining positions of maximum valued components in the codevector and determining positions of non maximum valued non-zero components in the codevector. Calculating the index for the codevector may then comprise combining at least a term representing the determined number of non-zero components, a term representing the determined number of maximum valued components, a term representing determined positions of maximum valued components, a term representing determined positions of non maximum valued non-zero components and a term representing determined signs of non-zero components.

In a corresponding embodiment of the second aspect of the invention, separate information on a number of the non-zero components in the codevector and on a number of maximum valued components in the codevector is extracted in addition from the index. Further, extracting information on positions of non-zero components from the index may comprise extracting separate information on positions of the maximum valued components and on positions of non maximum valued non-zero components. A codevector may then be assembled, which complies with the extracted information on a number of the non-zero components, on a number of maximum valued components, on positions of the maximum valued components, on positions of the non maximum valued non-zero components and on signs of the non-zero components.

In another embodiment of the first aspect of the invention proceeding from the preceding example, for example, values of non maximum valued non-zero components could be determined in addition. The index for the codevector could then be calculated by combining in addition at least a term representing determined values of non maximum valued non-zero components.

In a corresponding embodiment of the second aspect of the invention, separate information on values of non maximum valued non-zero components is extracting in addition from the index. A codevector may then be assembled, which complies in addition with the extracted information on values of non maximum valued non-zero components.

With the codevector information used for indexing in the latter embodiment, the codevector can be reconstructed completely. If only a part of this information is transmitted and received or read at an apparatus according to the second aspect of the invention, the assembled codevector will be only an approximation of the original codevector.

Which characteristics of the codevector are determined and included as separate information in the index may depend on at least one predetermined criterion.

Such a criterion might be a current bitrate restriction for the index when creating the index. That is, the more bits are available, the more information may be included in the index and are extracted from the index, which enables a scalability of the indexing. The bitrate restrictions may be given for example by a transmission channel or by some, in terms of bitrate, more demanding part of the encoding procedure.

A scalability of the indexing enables a scalable coding and/or allows borrowing bits for error protection in the case of a noisy transmission channel. By using less information in an index, the saved bits could be borrowed for instance for error protection of the most important information in the case of a noisy transmission channel. The scalability could also be used for adjusting the total number of bits of a transmission, though.

In the first aspect of the invention, a respective codevector may be obtained by converting an audio signal into codevectors that are associated to a respective point of an outer shell of a respective rectangular truncated lattice. An index may then be determined for each of these codevectors.

In the second aspect of the invention, a respective reconstructed codevector may be converted into an audio signal.

The proposed indexing can be applied for example to a Zₙ lattice or to lattices having as cosets the Zₙ lattice. It can be applied whenever the outer shell of a rectangular truncation of such a lattice is used for quantization. The proposed indexing could also be used for the entire rectangular truncation of a lattice by considering each of its shells separately.

It is to be understood that all presented exemplary embodiments may also be used in any suitable combination.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a system according to an embodiment of the invention;

FIG. 2 is a diagram illustrating an exemplary selection of one out of three different indexing variants in the system of FIG. 1;

FIG. 3 is a flow chart illustrating an exemplary first indexing variant;

FIG. 4 is a flow chart illustrating an exemplary second indexing variant;

FIG. 5 is a flow chart illustrating an exemplary third indexing variant;

FIG. 6 is a diagram illustrating an exemplary selection of one out of three different inverse indexing variants in the system of FIG. 1;

FIG. 7 is a flow chart illustrating an exemplary first inverse indexing variant;

FIG. 8 is a flow chart illustrating an exemplary second inverse indexing variant;

FIG. 9 is a flow chart illustrating an exemplary third inverse indexing variant; and

FIG. 10 is a schematic block diagram of a device according to an embodiment of the invention.

### DETAILED DESCRIPTION OF THE INVENTION

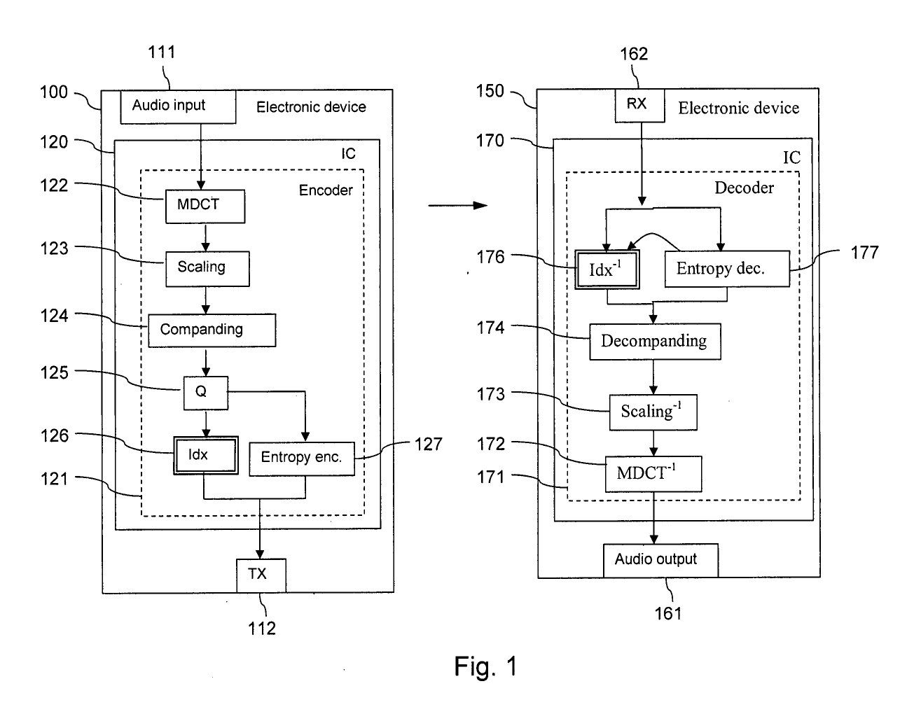

FIG. 1 is a schematic block diagram of an exemplary system, in which an audio coding using an indexing in accordance with the invention can be implemented.

The system comprises a first electronic device 100 and a second electronic device 150. The first electronic device 100 is configured to encode audio data and the second electronic device 150 is configured to decode encoded audio data.

Electronic device 100 comprises an audio input component 111, which is linked via a chip 120 to a transmitting component (TX) 112.

The audio input component 111 can be for instance a microphone or an interface to another device providing audio data.

The chip 120 can be for instance an integrated circuit (IC), which includes circuitry for an audio encoder 121, of which the functional blocks are illustrated schematically. They include a modified discrete cosine transform (MDCT) component 122, a scaling component 123, a companding component 124, a quantization (Q) component 125, an indexing (Idx) component 126 and an entropy encoding component 127.

The transmitting component 112 is configured to enable a transmission of data to another device, for example to electronic device 150, via a wired or a wireless link.

It is to be understood that the depicted connections can be realized via various components not shown.

The encoder 121 or the chip 120 could be seen as an exemplary first apparatus according to the invention.

Electronic device 150 comprises a receiving component 162, which is linked via a chip 170 to an audio output component 161.

The receiving component 162 is configured to enable a reception of data from another device, for example from electronic device 100, via a wired or a wireless link.

The chip 170 can be for instance an integrated circuit, which includes circuitry for an audio encoder 171, of which the functional blocks are illustrated schematically. They include an entropy decoding component 177, an inverse indexation component 176, a decompanding component 174, an inverse scaling component 173, and an inverse MDCT component 172.

The audio output component 161 can be for instance a loudspeaker or an interface to another device to which decoded audio data is to be forwarded.

It is to be understood that the depicted connections can be realized via various components not shown.

The decoder 171 or the chip 170 could be seen as an exemplary second apparatus according to the invention.

When an audio signal is input to electronic device 100, for example via the audio input component 111, it may be provided to the audio encoder 121 for encoding. Before the audio signal is provided to the audio encoder 121, it may be subjected to some pre-processing. In case an input audio signal is an analog audio signal, for instance, it may first be subjected to an analog-to-digital conversion, etc.

In the audio encoder 121, the MDCT component 122 MDCT transforms an input digital audio signal into the frequency domain. Next, the scaling component 123 scales the spectral components of a plurality of frequency sub-band of the frequency domain signal with a respective scaling factor. This scaling can be, for example, a downscaling with a first and/or a second scaling factor.

The scaled spectral components of the sub-bands are provided to companding component 124, which compands the spectral components. The quantization component 125 multiplies the companded spectral components by a third scaling factor and quantizes the resulting spectral components using a lattice quantization. The scaling may also be carried out outside the quantization component 125.

For the quantization of the companded data, the quantization component 125 is configured to use a rectangular truncated Zₙ lattice vector quantization for each spectral sub-band, for example at each 1024 length quantization frame. Besides the Zₙ lattice, other lattices could be used as well.

A Zₙ lattice contains all integer coordinate points of the n-dimensional space. The dimension of the respective Zₙ lattice may be equal to the number of spectral components in the respective sub-band. If a Zₙ lattice is used, the lattice quantization corresponds to rounding the scaled spectral components to the nearest integer to obtain quantized spectral components.

In a truncated lattice, the number of points of the lattice is limited. A finite truncation of the lattice forms a ‘codebook’ and a respective point can be represented by a ‘codevector’ listing a value for each dimension.

A rectangular truncated lattice, in which the codevector is included, allows for a simple indexing algorithm. A rectangular truncation Λ_{K} of the lattice Λ is defined as:

$${Λ}_{K} = \{ ( {x}_{1} , {x}_{2} , … , {x}_{n} ) ∈ Λ \vert {max}_{i} \vert {x}_{i} \vert \leq K \} .$$

Here, n is the lattice dimension, x₁ to xₙ are the codevector components and K is the maximum norm of the truncated lattice. Thus, the maximum absolute value any component x₁ to xₙ of any codevector may take is equal to K.

A generalization of the above formula is a truncation Λ_{{K}_{ᵢ}_{}} having different maximum norm values Kᵢ along different dimensions:

Λ_{{K}_{ᵢ}_{}}={(x₁,x₂, . . . xₙ)εΛ|max|xᵢ|≦Kᵢ}.

For the presented embodiments, the same maximum norm along all the dimensions will be assumed, but generalization to an embodiment using different norms for different dimensions is straightforward.

The exterior shell Λ̅_{K} of the truncation is formed by the points:

$${\overline{Λ}}_{K} = \{ ( {x}_{1} , {x}_{2} , … , {x}_{n} ) ∈ Λ \vert {max}_{i} \vert {x}_{i} \vert = K \}$$

A point from the outer rectangular shell of a Zₙ lattice of maximum norm K is thus a vector of integer components having at least one component of an absolute value equal to K, while all other components have absolute values less or equal to K.

If the norm K of the truncated rectangular lattice is always selected to be equal to the maximum value of the components of a respective codevector, any codevector could be considered to be a point from the shell of a truncated lattice. The norm for a rectangular truncated lattice may further be selected separately for each sub-band to correspond to the norm, that is, the maximum absolute value, of a respective codevector representing the quantized spectral components of the sub-band.

Each codevector resulting in the quantization can be represented by a respective index. That is, instead of encoding each vector component separately, a single index may be generated and provided as an encoded audio signal for a respective vector, as will be described in more detail further below. The indexation component 126 performs this indexing for each sub-band.

In addition, information that has been used in the encoding and that is required for the decoding of the encoded audio signal may be encoded by the entropy encoder 127. Such information may include for instance an indication of the amount of scaling that has been applied. Moreover, also the norm for the rectangular truncated lattice cannot be known beforehand at the decoding end. Thus, this norm is equally entropy encoded so that it may be provided as further side information for the encoded audio signal.

The indices provided by the indexation component 126 and the encoded information provided by the entropy encoder 127 are multiplexed to a bitstream and transmitted by the transmission component 112 to electronic device 150.

At electronic device 150, the encoded bitstream is received by the receiving component 162 and provided to the decoder 171. In the decoder 171, the entropy decoding component 177 extracts encoding information from the bitstream. The entropy decoding component 177 provides the decoded norm to the inverse indexation unit 176. The inverse indexation component 176 reads an index from a binary word having a length given by the decoded norm K.

The inverse indexation component 176 then reconstructs the lattice codevector, as will be described in more detail further below.

The obtained components of the codevector are used by the decompanding component 174 to obtain a decompanded set of values. The inverse scaling component 173 scales the values with inverse scaling factors, which may also be obtained from the entropy decoding component 177. The scaled values are used by the inverse MDCT component 172 for obtaining a decoded audio signal.

The decoded audio signal may then be provided to the audio output component 161, possibly after some further processing, like a digital-to-analog conversion.

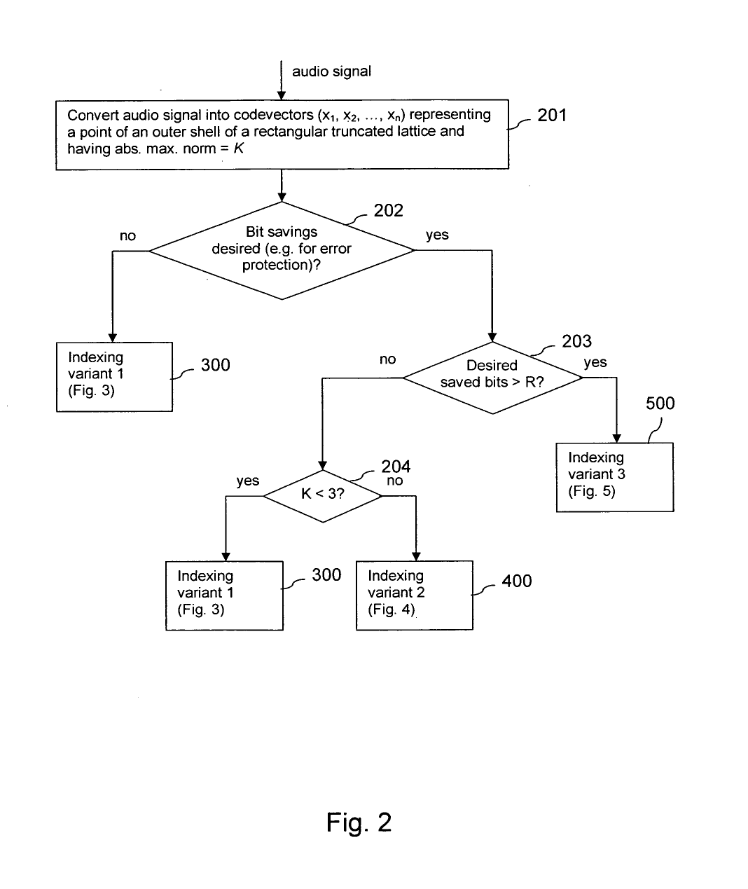

An exemplary scalable indexing by the indexation component 126 in accordance with an embodiment of the invention will now be described with reference to FIGS. 2 to 5.

FIG. 2 is a diagram illustrating a selection of a respective indexing variant.

In a preparatory operation, an audio signal is converted by MDCT component 122, scaling component 123, companding component 124 and quantization component 125 into codevectors (x₁, x₂, . . . , xₙ) having an absolute maximum norm=K, as described further above (step 201).

The indexing component 126 determines at first, whether there are currently any bitrate restrictions in the system, which make bit savings desirable (step 202), for instance in order to have some additional bits available for error protection purposes. The decision may be based for example on the current quality of an employed transmission channel or on a classification of the transmission.

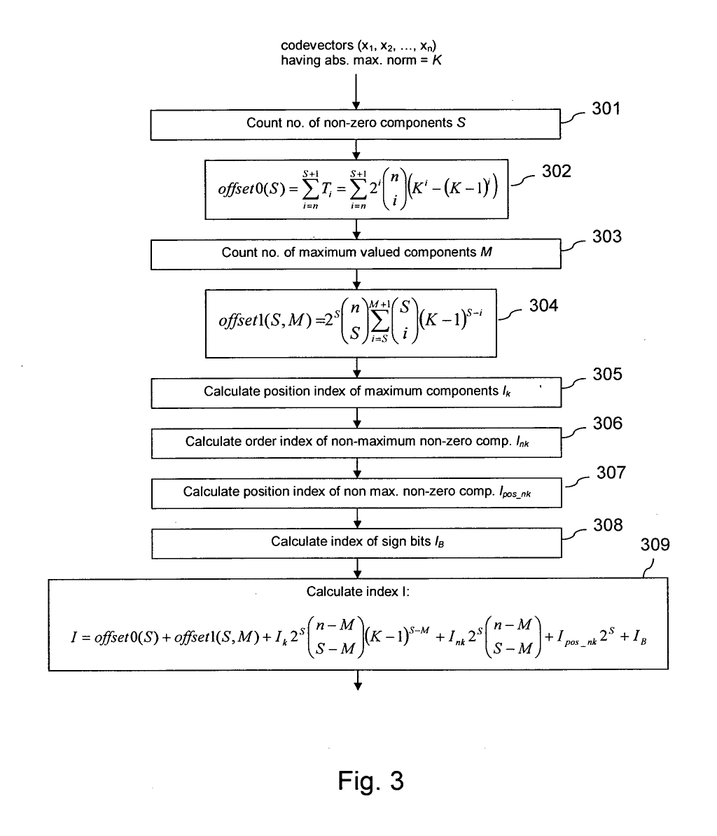

If no bit savings are needed, the indexing component 126 selects a first indexing variant (step 300), which will be described in more detail further below with reference to FIG. 3. This first indexing variant enables a lossless representation of lattice codevectors.

For the case that bit savings are desirable, two different lower bitrate indexing variants are available, which enable approximate representations of lattice codevectors with different degrees of approximation. If bit savings are desirable, the indexing component 126 therefore further compares the preferred amount of saved bits with a predetermined amount R (step 203).

If the preferred amount of saved bits does not exceed the predetermined amount R, the indexing component 126 checks further, whether the maximum norm K of the truncated lattice is at least equal to three, that is, K≧3 (step 204).

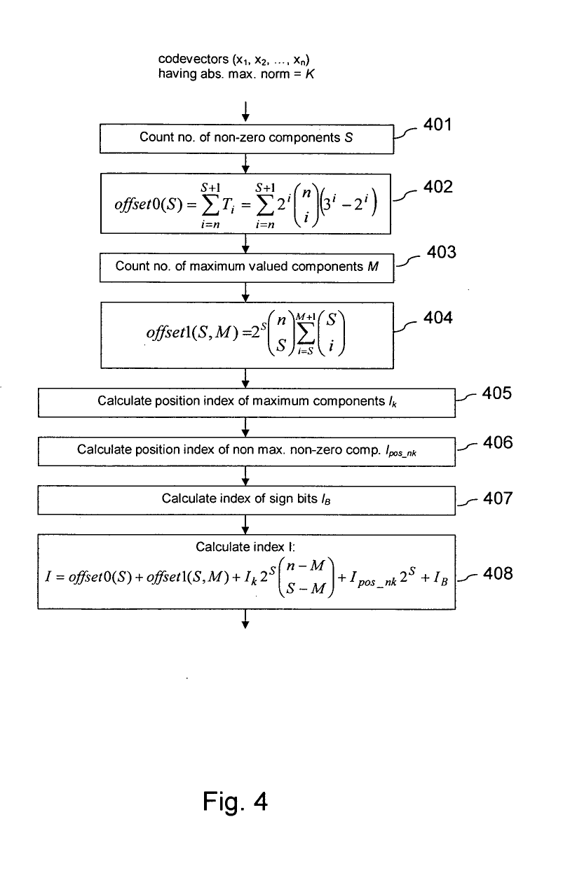

If K≧3, the indexing component 126 selects a second indexing variant (step 400), which allows saving a moderate amount of bits. This indexing variant will be described in more detail further below with reference to FIG. 4.

In this second indexing variant, however, bit savings are only realized compared to the first indexing variant, if K≧3.

In case K<3, therefore the first indexing variant is selected again (step 300).

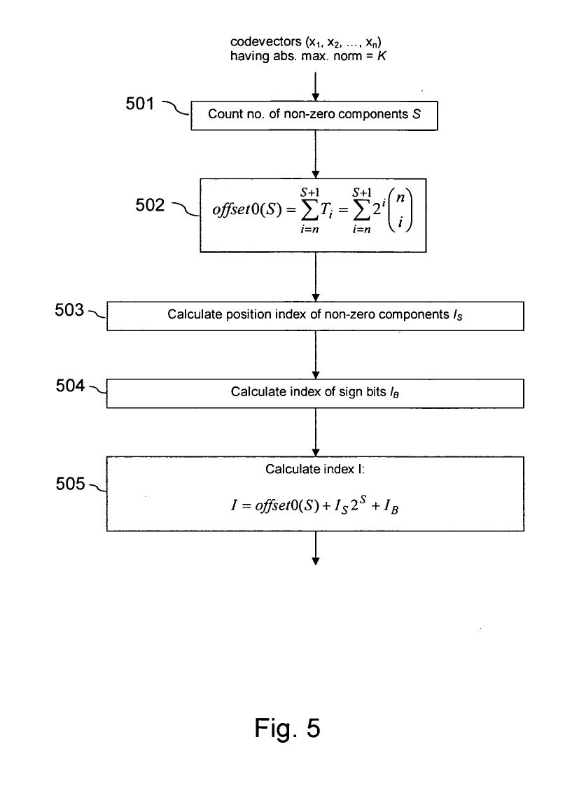

Finally, if the amount of bits that are to be saved exceeds the predetermined amount R, the indexing component 126 selects a third indexing variant (step 500), which will be described in more detail further below with reference to FIG. 5.

It is to be understood that the selection of the indexing variant could equally be performed by a separate decision block, which indicates a selected indexing variant to the indexing component 126.

The first indexing variant of FIG. 2 (300) will now be described with reference to the flow chart of FIG. 3.

The indexation component 126 receives as an input an n-dimensional integer codevector (x₁,x₂, . . . ,xₙ) having maximum absolute norm equal to K and representing a point from the outer rectangular shell of a truncated Zₙ lattice. The indexation component 126 outputs an integer index I for this codevector.

A codevector can be defined by the following information:
(A) the number of the significant components of the codevector, all non-zero components being considered as significant components;
(B) the number of maximum valued components of the codevector, considering absolute values of the components;
(C) the position of the maximum valued components;
(D) the values of the non maximum valued significant components of the codevector;
(E) the position of the non maximum valued significant components;
(F) the signs of the significant components.

It is to be understood that the codevector could equally be defined in various other ways. For illustration, one exemplary variation is presented:
(a) the number of the significant components of the codevector, all non-zero components being considered as significant components;
(b) the number of maximum valued components of the codevector, considering absolute values of the components;
(c) the position of significant components;
(d) the position of maximum valued components within the significant ones;
(e) the values of the non maximum valued significant components of the codevector;
(f) the signs of the significant components.

While the following description presents algorithms for the first grouping of information (A) to (F), similar algorithms can be derived for the presented varied grouping of information (a) to (f) or for any other desired grouping.

The indexation component 126 makes use of the structuralization of codevector information by incorporating information (A) to (F) as separable pieces of information in the index of a codevector.

For taking account of information (A), the indexation component 126 counts the number S of significant components of the codevector (step 301). Based on this number S, the indexation component 126 then calculates a first offset (step 302):

$$offset 0 ( S ) = {\sum }_{i = n}^{S + 1} {2}^{i} ( \begin{matrix}n \\ i\end{matrix} ) ( {K}^{i} - {( K - 1 )}^{i} )$$

For taking account of information (B), the indexation component 126 counts the number M of maximum valued components of the codevector. More specifically, it counts the components having an absolute value equal to K (step 303). Based on this number M and the previously determined number S, the indexation component 126 then calculates a second offset (step 304):

$$offset 1 ( S , M ) = {2}^{S} ( \begin{matrix}n \\ S\end{matrix} ) {\sum }_{i = S}^{M + 1} ( \begin{matrix}S \\ i\end{matrix} ) {( K - 1 )}^{S - i}$$

For taking account of information (C), the indexation component 126 then determines a position index Iₖ of the maximum valued components (step 305). This position index Iₖ indicates the positions of the maximum valued components relative to the whole vector length. Such a position index Iₖ can be calculated, for instance, using the enumeration algorithm for binomial coefficients presented by A. Vasilache and I. Tabus in: “Robust indexing of lattices and permutation codes over binary symmetric channels”, Signal Processing vol. 83, no. 7, pp. 1467-1486, 2003.

In this approach, the input of the enumeration algorithm may be for example the vector z=(z₁,z₂, . . . ,zₙ)ε{0,1}ⁿ such that there are exactly M unitary components in the vector, at positions corresponding to the positions of maximum valued components in the codevector. Additionally, a position vector p=(p₀, . . . ,p_{M-1})ε{0, . . . ,n−1}^{M} is created, which specifies the exact location of each of the maximum valued component. Since there are

$$( \begin{matrix}n \\ M\end{matrix} )$$

such z vectors, they can be enumerated like binomial coefficients following the algorithm given by the next equations:

$${I}_{pos} ( n , M , p ) = {\sum }_{i = 1}^{{p}_{0}} ( \begin{matrix}n - i \\ M - 1\end{matrix} ) + {I}_{pos} ( n - {p}_{0} - 1 , M - 1 , ( {p}_{1} , … , {p}_{M - 1} ) - {p}_{0} - 1 )$$

$$and$$

$${I}_{pos} ( {n}^{′} , 1 , [ i ] ) = i , 0 \leq i < {n}^{′} \leq n .$$

### Iₚₒₛ can then be used as the desired position index Iₖ.

For taking account of information (D), the indexation component 126 determines an order index Iₙₖ of non maximum valued significant components (step 306). This can be realized for instance by using a base representation indexing computation. For instance, if a vector of exclusively the (S−M) significant, but non maximum valued components is given by (y₁,y₂, . . . ,y_{S-M}), the order index can be calculated as:

$${I}_{nk} = {\sum }_{i = 1}^{S - M} {( 2 K - 1 )}^{( i - 1 )} ( {y}_{i} + K - 1 ) .$$

For taking account of information (E), the indexation component 126 determines a position index Iₚₒₛ_{_{—}}ₙₖ of the non-maximum significant components (step 307). This position index Iₚₒₛ_{_{—}}ₙₖ is calculated relative to the length of the vector without the maximum valued components, though, not relative to the whole vector length. Such a position index can be calculated again, for instance, using the enumeration algorithm for binomial coefficients presented in above cited document “Robust indexing of lattices and permutation codes over binary symmetric channels”. In this case, exclusively the non-maximum valued non-zero components are considered instead of the maximum valued components for generating a vector x. Iₚₒₛ can then be used as the desired position index Iₚₒₛ_{_{—}}ₙₖ.

For taking account of information (F), the indexation component 126 determines an index of sign bits, I_{B} (step 308). This binary representation of the S bits long index I_{B} could include for instance a ‘zero’ bit for a negative valued component and a ‘one’ bit for each positive valued component in the order of the significant components.

The index I_{B} is obtained then as:

$${I}_{B} = {\sum }_{i = 1}^{S} {b}_{i} {2}^{i - 1} ,$$

where bᵢ is 0 if the i-th significant component is negative and 1 otherwise.

Finally, the indexation component 126 combines the first offset values, the second offset and indices Iₖ, Iₙₖ, Iₚₒₛ_{_{—}}ₙₖ and I_{B} to an index I (step 309):

$$I = offset 0 ( S ) + offset 1 ( S , M ) + {I}_{k} {2}^{S} ( \begin{matrix}n - M \\ S - M\end{matrix} ) {( K - 1 )}^{S - M} + {I}_{nk} {2}^{S} ( \begin{matrix}n - M \\ S - M\end{matrix} ) + {I}_{pos\_nk} {2}^{S} + {I}_{B}$$

Terms

$${I}_{k} {2}^{S} ( \begin{matrix}n - M \\ S - M\end{matrix} ) {( K - 1 )}^{S - M} and {I}_{pos\_nk} {2}^{S}$$

are thus exemplary terms representing determined positions of non-zero components and I_{B} is an exemplary term representing determined signs of components. The factors by which indices Iₖ, Iₙₖ and Iₚₒₛ_{_{—}}ₙₖ are multiplied for the summation ensure that the first offset values, the second offset and indices Iₖ, Iₙₖ, Iₚₒₛ_{_{—}}ₙₖ and I_{B} can be recovered again as separate values from index I at a decoding end.

The resulting index I is then provided together with the entropy encoded information for transmission to electronic device 150.

The second indexing variant of FIG. 2 (400) will now be described with reference to the flow chart of FIG. 4.

The indexation component 126 receives again as an input an n-dimensional integer codevector (x₁,x₂, . . . ,xₙ) having a maximum absolute norm equal to K and representing a point from the outer rectangular shell of a Zₙ lattice, the codevector being provided by quantization component 125. The indexation component 126 provides again as an output an integer index I for this codevector.

The indexation component 126 makes use again of a structuralization of the codevector information into information (A) to (F) listed above. In this case, however, the index I includes only selected pieces of information, namely pieces of information (A), (B), (C), (E), and (F).

For taking account of information (A), the indexation component 126 counts the number S of significant components of the codevector (step 401). Based on this number S, the indexation component 126 then calculates a first offset (step 402):

$$offset 0 ( S ) = {\sum }_{i = n}^{S + 1} {T}_{i} = {\sum }_{i = n}^{S + 1} {2}^{i} ( \begin{matrix}n \\ i\end{matrix} ) ( {3}^{i} - {2}^{i} )$$

For taking account of information (B), the indexation component 126 counts the number M of maximum valued components. More specifically, it counts the components having an absolute value equal to K (step 403). Based on this number M and the previously determined number S, the indexation component 126 then calculates (step 404):

$$offset 1 ( S , M ) = {2}^{S} ( \begin{matrix}n \\ S\end{matrix} ) {\sum }_{i = S}^{M + 1} ( \begin{matrix}S \\ i\end{matrix} )$$

For taking account of information (C), the indexation component 126 then determines a position index Iₖ of the maximum valued components (step 405). This position index Iₖ indicates again the positions of the maximum valued components relative to the whole vector length. Such a position index can be calculated again, for instance, using the enumeration algorithm for binomial coefficients presented in the above cited document “Robust indexing of lattices and permutation codes over binary symmetric channels”.

For taking account of information (E), the indexation component 126 determines a position index Iₚₒₛ_{_{—}}ₙₖ of the non-maximum significant components (step 406). This position index Iₚₒₛ_{_{—}}ₙₖ is calculated again relative to the length of the vector without the maximum valued components. Such a position index can be calculated again, for instance, using the enumeration algorithm for binomial coefficients presented in above cited document “Robust indexing of lattices and permutation codes over binary symmetric channels”.

For taking account of information (F), the indexation component 126 determines an index of sign bits, I_{B} (step 407).

Finally, the indexation component 126 combines the first offset, the second offset and the indices Iₖ, Iₚₒₛ_{_{—}}ₙₖ and I_{B} to an index I according to the following equation (step 408):

$$I = offset 0 ( S ) + offset 1 ( S , M ) + {I}_{k} {2}^{S} ( \begin{matrix}n - M \\ S - M\end{matrix} ) + {I}_{pos\_nk} {2}^{S} + {I}_{B}$$

Terms

$${I}_{k} {2}^{S} ( \begin{matrix}n - M \\ S - M\end{matrix} ) and {I}_{pos\_nk} {2}^{S}$$

are thus exemplary terms representing determined positions of non-zero components and I_{B} is an exemplary term representing determined signs of components. The factors by which indices Iₖ and Iₚₒₛ_{_{—}}ₙₖ are multiplied for the summation ensure that the first offset values, the second offset and indices Iₖ, Iₚₒₛ_{_{—}}ₙₖ and I_{B} can be recovered again as separate values from index I at a decoding end. Since index Iₙₖ is missing though, these factors and the offset calculations are different from the first indexing variant presented with reference to FIG. 3.

The determined index I may then provided together with the entropy encoded information for transmission to electronic device 150.

When the norm K of the codevector is smaller than 3, the exact vector representation is encoded/decoded in accordance with the first indexing variant (step 300), as indicated above, because the information that is skipped by this second indexing variant, namely the values of the non-maximum valued components, is already known, being 1 if K=2 and no non-maximum values for K=1.

In the third indexing variant of FIG. 2 (500), which will now be described with reference to the flow chart of FIG. 5, the index I includes even less pieces of information than in the second indexing variant, namely only pieces of information (A), (C), (E) and (F).

For taking account of information (A), the indexation component 126 counts the number S of significant components in the codevector (step 501). Based on this number S, the indexation component 126 then calculates a single offset (step 502):

$$offset 0 ( S ) = {\sum }_{i = n}^{S + 1} {T}_{i} = {\sum }_{i = n}^{S + 1} {2}^{i} ( \begin{matrix}n \\ i\end{matrix} )$$

Information (C) and (E) are considered as combined information (C+E). That is, the position of all significant components is considered in common, not separately for maximum valued and non maximum valued components. For taking account such information (C+E), the indexation component 126 determines a position index I_{S} of all significant components (step 503). The considered positions are determined relative to the whole vector length. Such a position index I_{S} can be calculated again, for instance, using the enumeration algorithm for binomial coefficients presented in the above cited document “Robust indexing of lattices and permutation codes over binary symmetric channels”.

For taking account of information (F), the indexation component 126 determines an index of sign bits, I_{B} (step 504).

Finally, the indexation component 126 combines the offset and the indices I_{S} and I_{B} to an index I according to the following equation (step 505):

I=offset0(S)+I_{S}2^{S}+I_{B}

Term I_{S}2^{S} is thus an exemplary term representing determined positions of non-zero components and I_{B} is an exemplary term representing determined signs of components. Due to the reduced number of terms, only a factor for index I_{S} has to be provided in the summation in order to ensure that the offset and indices I_{S} and I_{B} can be recovered again as separate values from index I at a decoding end.

This index I may then provided together with the entropy encoded information for transmission to electronic device 150.

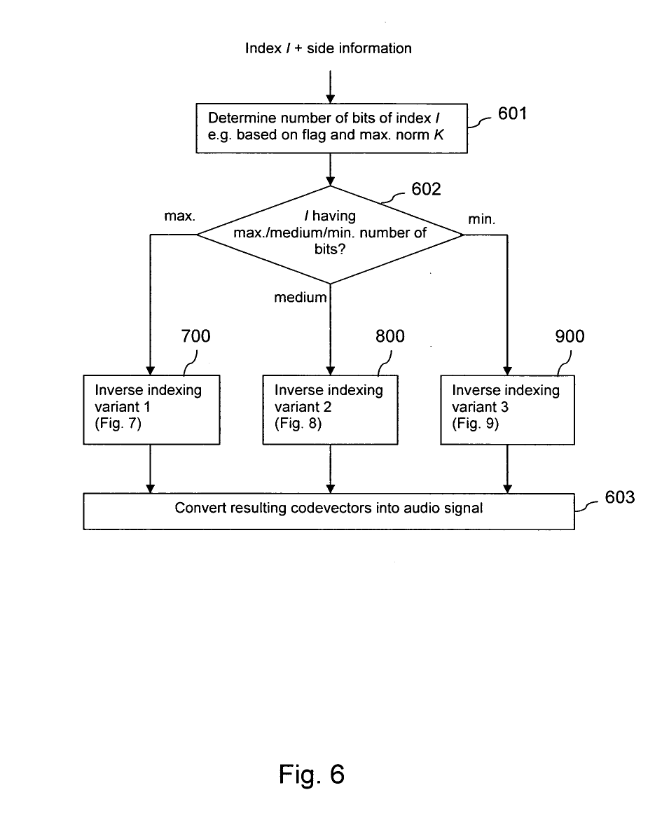

An exemplary embodiment of a corresponding inverse indexing by the inverse indexation component 176 will now be described with reference to FIGS. 6 to 9.

FIG. 6 is a diagram illustrating a selection of a respective inverse indexing variant.

The inverse indexing component 176 determines at first the number of bits of an index I read from a binary word of a bitstream received by electronic device 150 (step 601).

There are different possibilities how the inverse indexing component 176 could determine the employed type of indexing and thus the number of bits of index I. The type of indexing can be decided on a frame by frame basis based, for instance, on the channel condition information, if such information is available also at the decoder 171. Additionally, if the channel condition is available both at the encoding and at the decoding end, the type of indexing could be decided on a codevector by codevector basis, following a similar algorithm at the encoding and the decoding end to decide the type of indexing for each codevector of the current frame. If no channel condition information is available at the decoder 171, or if the type of indexing is selected based on other criteria than channel conditions, a supplementary flag could be sent per frame to indicate the type of indexing. Such a flag could have a maximum length of two bits. The value of maximum norm K for each codevector for which an index I is received, which is derived from the side information, together with this flag allows determining the number of bits that should be read for the codevector's index I.

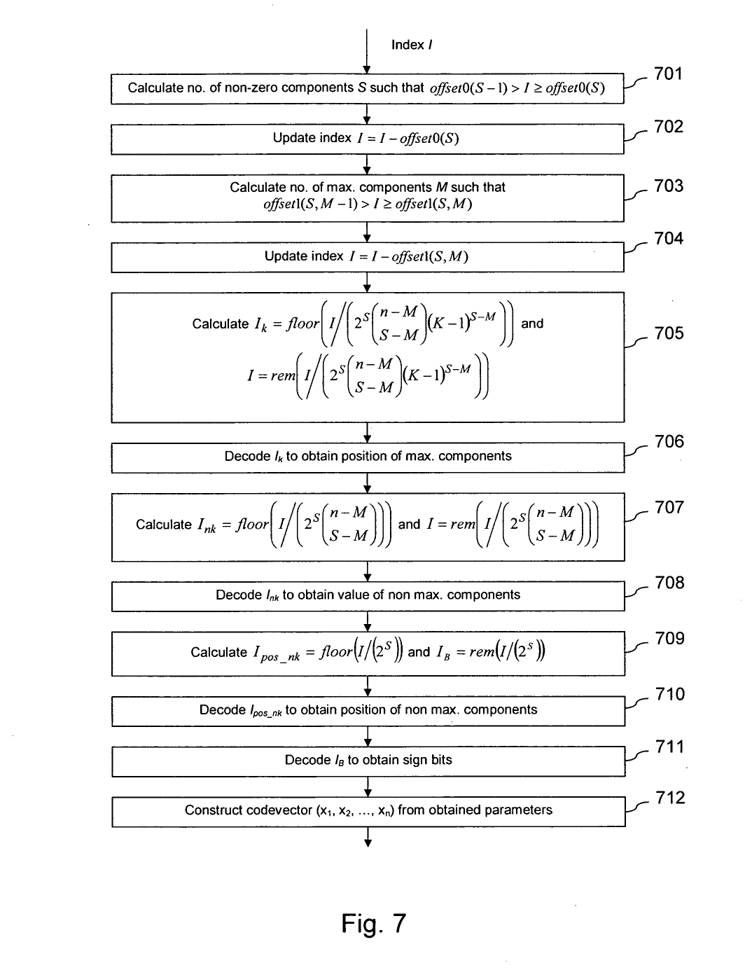

If the received index I comprises a maximum number of bits for a given value of K (step 602), the inverse indexing component 176 selects a first inverse indexing variant (step 700), which will be described in more detail further below with reference to FIG. 7.

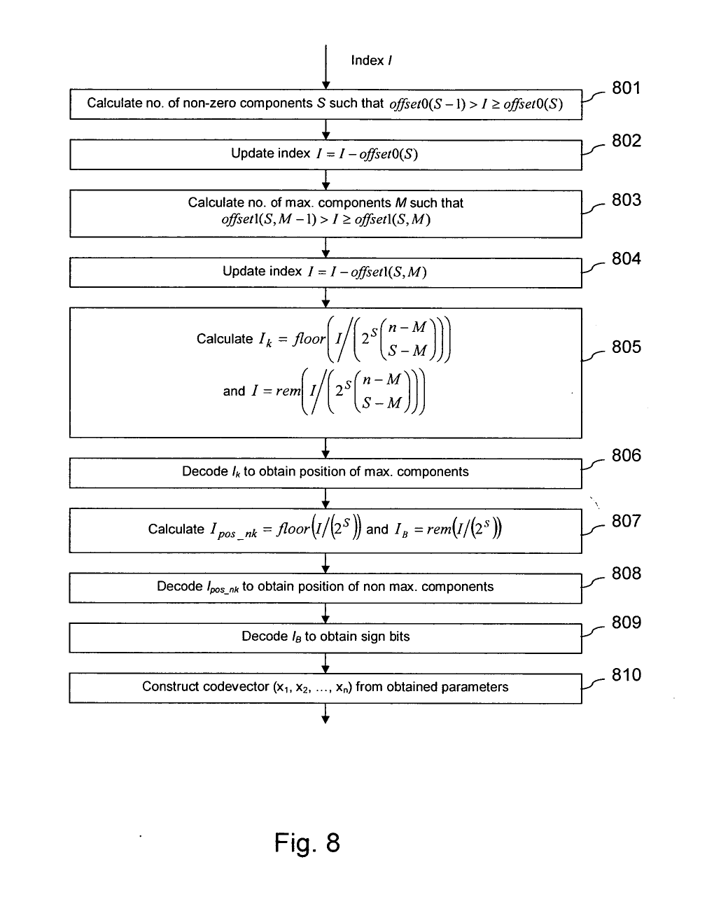

If received index I comprises a medium number of bits for a given value of K (step 602), the inverse indexing component 176 selects a second inverse indexing variant (step 800), which will be described in more detail further below with reference to FIG. 8.

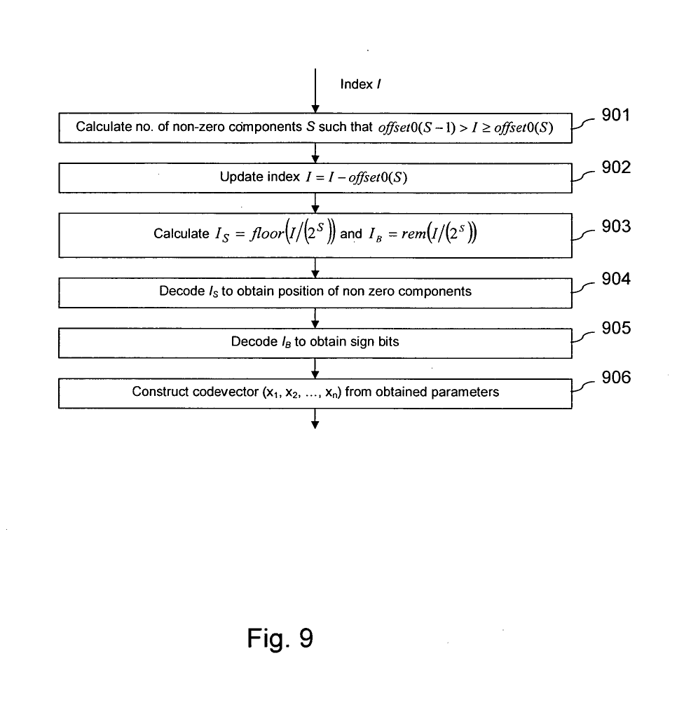

If received index I comprises a minimum number of bits for a given value of K (step 602), the inverse indexing component 176 selects a third inverse indexing variant (step 900), which will be described in more detail further below with reference to FIG. 9.

The codevectors resulting in the respectively selected inverse indexing variant are then provided for processing by decompanding component 174, inverse scaling component 173 and inverse MDCT component 172, as described above, for converting the codevector into a decoded audio signal (step 603).

The first inverse indexing variant of FIG. 6 (700) will now be described with reference to the flow chart of FIG. 7.

The inverse indexation component 176 uses as an input the index I. The inverse indexation component 176 outputs an n-dimensional integer codevector, which has a maximum absolute norm equal to K and which represents a point from the outer rectangular shell of a Zₙ lattice.

Based on the received index I, the inverse indexation component 176 first regains the included pieces of information (A) to (F) listed above.

For regaining information (A), the inverse indexation component 176 calculates a number S of significant components such that the relation offset0(S−1)>I≧offset0(S) holds, using the above indicated equation for the first offset (step 701).

Index I is then updated by removing the determined first offset: I=I−offset0(S) (step 702).

For regaining information (B), the inverse indexation component 176 calculates the number M of maximum valued components, considering again the absolute value, such that the relation offset1(S,M−1)>I≧offset1(S,M) holds, using the above equation for the second offset (step 703).

Index I is then further updated by removing the determined second offset: I=I−offset1(S,M) (step 704).

For regaining information (C), the inverse indexation component 176 calculates a position index Iₖ using the following equation:

$${I}_{k} = floor ( I / ( {2}^{S} ( \begin{matrix}n - M \\ S - M\end{matrix} ) {( K - 1 )}^{S - M} ) )$$

and updates index I as follows:

$$I = rem ( I / ( {2}^{S} ( \begin{matrix}n - M \\ S - M\end{matrix} ) {( K - 1 )}^{S - M} ) ) ( step 705 ) .$$

The function floor (a) provides the largest integer less than or equal to real number a. The function rem (b/c) provides the remainder when b is divided by c.

The inverse indexation component 176 then decodes Iₖ to obtain the position of the maximum valued components within the whole codevector (step 706). This decoding can be realized again using the enumeration algorithm for binomial coefficients presented in above cited document “Robust indexing of lattices and permutation codes over binary symmetric channels”.

That is, for the example presented above with reference of steps 305, to recover the position vector p from an index Iₖ=Iₚₒₛ, the following algorithm may be used:

1. i = 0
2. while (M > 0) {

find j such that ${\sum }_{i = 1}^{j} ( \begin{matrix}n - i \\ M - 1\end{matrix} ) \leq {I}_{pos} < {\sum }_{i = 1}^{j + 1} ( \begin{matrix}n - i \\ M - 1\end{matrix} )$
pᵢ = j
${I}_{pos} = {I}_{pos} - {\sum }_{i = 1}^{j} ( \begin{matrix}n - i \\ M - 1\end{matrix} )$
n = n − j − 1
M = M − 1
i = i + 1

}

The vector z may then be recovered by inserting the value 1 at the positions indicated in the vector p and the value 0 at all the other positions.

For regaining information (D), the inverse indexation component 176 calculates an order index Iₙₖ:

$${I}_{nk} = floor ( I / ( {2}^{S} ( \begin{matrix}n - M \\ S - M\end{matrix} ) ) )$$

and updates index I as follows:

$$I = rem ( I / ( {2}^{S} ( \begin{matrix}n - M \\ S - M\end{matrix} ) ) ) ( step 707 ) . \qquad$$

The inverse indexation component 176 then decodes Iₙₖ (step 708) to obtain the values of the non maximum valued significant components, that is, of those significant components, which have an absolute value of less than K:

(y′_{S-M} . . . y′₁)=(Iₙₖ)_{(K-1)} and yᵢ=y′ᵢ−(K−1), i=1:S−M

where (Iₙₖ)_{(K-1)} represents the (K−1) base representation of Iₙₖ.

For regaining information (E) and (F), the inverse indexation component 176 calculates a position index Iₚₒₛ_{_{—}}ₙₖ:

Iₚₒₛ_{_{—}}ₙₖ=floor(I/(2^{S})),

where the remaining updated index I represents the index of sign bits I_{B}:

I_{B}=rem(I/(2^{S})) (step 709)

The inverse indexation component 176 then decodes the index Iₚₒₛ_{_{—}}ₙₖ to obtain the position of the non maximum valued significant components within the whole vector without the maximum valued components (step 710). This decoding can be realized again using the enumeration algorithm for binomial coefficients presented in above cited document “Robust indexing of lattices and permutation codes over binary symmetric channels”, similarly as described above for the maximum valued components in step 706.

Moreover, the inverse indexation component 176 decodes the index I_{B} to obtain the sign bits (step 711).

Finally, the inverse indexation component 176 reconstructs a codevector based on pieces of information (A) to (F) (step 712).

The reconstructed codevector is then provided for conversion into a decoded audio signal.

The results of the presented exemplary first indexing variant and first inverse indexing variant have been compared to the results with a base representation indexing method. More specifically, the resulting Euclidean distortions in the codevector domain have been compared.

The base representation indexing method used at the encoding end as an input as well an n-dimensional integer vector (x₁,x₂, . . . ,xₙ) having maximum absolute norm equal to K and provided as an output the integer index I obtained according to the following equation:

$$I = {\sum }_{i = 1}^{n} {( 2 K + 1 )}^{( i - 1 )} ( {x}_{i} + K )$$

At the decoding end, the integer index I formed the input, while the output was an n-dimensional integer vector having a maximum absolute norm equal to K, where the index is represented in the base (2K+1).

The following table presents the Euclidean distortion resulting on an average for different bit error rate (BER) values when using this base representation indexing method. The table further presents the Euclidean distortion resulting with the presented approach when using an increasing order for the number of significant components and an increasing order for the number of maximum valued components. The table moreover presents the Euclidean distortion resulting with the presented approach when using a decreasing order for the number of significant components and an increasing order for the number of maximum valued components. A decreasing order means that the codevectors with a larger number of significant values have the smaller indices. Such an order was assumed in the above presented examples. The ordering is reflected in the indices of summation for offset0 (step 302), which decrease from n downwards, and in the formula for offset1 (step 304). Thus, the equations have to be slightly adapted if an increasing ordering is used instead, in which the codevectors with a larger number of significant values have the larger indices.

| | BER = 5/ | BER = 10/ | BER = 100/ |
|---|---|---|---|
| | 1000 | 1000 | 1000 |
| Base | 0.3779 | 0.7036 | 3.0843 |
| representation | | | |
| Presented | 0.2470 | 0.4680 | 2.4572 |
| approach, 1^{st} | | | |
| option | | | |
| Presented | 0.2221 | 0.4194 | 2.1136 |
| approach, 2^{nd} | | | |
| option | | | |

It can be seen that the presented method provides better results than a base representation approach. Moreover, the performance of the indexing method using a decreasing order of significant components is better than the performance of the indexing method using an increasing order of significant components. The same differentiation could be used with respect to the number of non maximum valued components.

Additional informal listening tests agree with the numerical results and demonstrate the superiority of the presented method.

The second inverse indexing variant of FIG. 6 (800) will now be described with reference to the flow chart of FIG. 8.

The inverse indexation component 176 uses as an input again the index I. The inverse indexation component 176 outputs again an n-dimensional integer codevector having maximum absolute norm equal to K and representing a point from the outer rectangular shell of a Zₙ lattice.

For regaining information (A), the inverse indexation component 176 calculates the number S of significant components such that the relation offset0(S−1)>I≧offset0(S) holds (step 801).

Index I is then updated by removing the determined first offset: I=I−offset0(S) (step 802).

For regaining information (B), the inverse indexation component 176 calculates the number M of maximum valued components such that the relation

offset1(S,M−1)>I≧offset1(S,M) holds (step 803).

Index I is then further updated by removing the determined second offset: I=I−offset1(S,M) (step 804).

For reconstructing information (C), the inverse indexation component 176 calculates a position index Iₖ:

$${I}_{k} = floor ( I / ( {2}^{S} ( \begin{matrix}n - M \\ S - M\end{matrix} ) ) )$$

and updates index I as follows:

$$I = rem ( I / ( {2}^{S} ( \begin{matrix}n - M \\ S - M\end{matrix} ) ) ) ( step 805 ) . \qquad$$

The inverse indexation component 176 then decodes index Iₖ to obtain the position of the maximum valued components within the whole vector (step 806). This decoding can be realized for example again using the enumeration algorithm for binomial coefficients presented in above cited document “Robust indexing of lattices and permutation codes over binary symmetric channels”.

For reconstructing information (E) and (F), the inverse indexation component 176 calculates a position index Iₚₒₛ_{_{—}}ₙₖ:

Iₚₒₛ_{_{—}}ₙₖ=floor(I/(2^{S})),

where a remaining updated index I represents the index of sign bits I_{B}:

I_{B}=rem(I/(2^{S})) (step 807).

The inverse indexation component 176 then decodes the index Iₚₒₛ_{_{—}}ₙₖ to obtain the position of the non maximum valued significant components within the whole vector without the maximum values (step 808). This decoding can be realized for example again using the enumeration algorithm for binomial coefficients presented in above cited document “Robust indexing of lattices and permutation codes over binary symmetric channels”.

Moreover, the inverse indexation component 176 decodes the index I_{B} to obtain the sign bits (step 809).

Finally, the inverse indexation component 176 reconstructs an approximated codevector based on regained information (A), (B), (C), (E) and (F). Since piece of information (D) is missing, a value of ‘1’ is used for the non-maximum valued components in the reconstruction.

The reconstructed codevector may then be further processed as described above with reference to FIG. 1.

The third inverse indexing variant of FIG. 6 (900) will now be described with reference to the flow chart of FIG. 9.

The inverse indexation component 176 uses as an input again index I. The inverse indexation component 176 outputs again an n-dimensional integer codevector having maximum absolute norm equal to K and representing a point from the outer rectangular shell of a Zₙ lattice.

For reconstructing information (A), the inverse indexation component 176 calculates the number S of significant components such that the relation offset0(S−1)>I≧offset0(S) holds (step 901).

Index I is then updated by removing the determined offset: I=I−offset0(S) (step 902).

For reconstructing information (C+E) and (F), the inverse indexation component 176 calculates a position index I_{S}:

I_{S}=floor(I/(2^{S}))

and updates index I as follows:

I=rem(I/(2^{S})) (step 903).

The inverse indexation component 176 then decodes index I_{S} to obtain the position of all significant components within the whole vector (step 904). This decoding can be realized for example again using the enumeration algorithm for binomial coefficients presented in above cited document “Robust indexing of lattices and permutation codes over binary symmetric channels”.

The remaining updated index I represents the index of sign bits I_{B}. The inverse indexation component 176 decodes the index I_{B} to obtain the sign bits of all significant codevector components (step 905).

Finally, the inverse indexation component 176 reconstructs an approximated codevector based on regained information (A), (C+E) and (F). Since piece of information (D) is missing, a value of ‘1’ could be used as well for the non-maximum valued components in the reconstruction. Another possibility is to use the maximum value, K, which is available from the side information.

The reconstructed codevector may then be further processed as described above with reference to FIG. 1.

Exemplary details for the processing by MDCT component 122, scaling component 123, companding component 124 quantization component 125, entropy encoding component 127, inverse MDCT component 172, inverse scaling component 173, decompanding component 174 and entropy decoding component 177 can be taken for instance from co-pending patent application U.S. Ser. No. 11/256,670.

FIGS. 2 to 5 could also be considered as presenting functional blocks of an indexation component 126 (excluding block 201), where blocks 202, 203 and 204 represent decision components, while all other blocks represent computing components configured to carry out the described functions. Similarly, FIGS. 6 to 9 could also be considered as presenting functional blocks of an inverse indexation component 176 (excluding block 603), where block 602 represents a decision component, while all other blocks represent a computing component configured to carry out the described functions.

Moreover, the functions illustrated by the indexation component 126 can be viewed as means for determining positions of non-zero components in a codevector, the codevector being associated to a point of an outer shell of a rectangular truncated lattice and representing audio data, as means for determining signs of these non-zero components in the codevector, and as means for calculating an index for the codevector by combining at least a term representing determined positions of non-zero components and a term representing determined signs of components. The functions illustrated by the inverse indexation component can be viewed as means for extracting from an index separate information on positions of non-zero components of a codevector and on signs of components of the codevector, the codevector being associated to a point of an outer shell of a rectangular truncated lattice and representing audio data, and as means for assembling a codevector complying with the extracted information on positions of the non-zero components and on signs of the non-zero components.

It is to be understood that the implementation presented with reference to FIGS. 1 to 9 can be modified in many ways.

In one exemplary alternative implementation, the indexing and inverse indexing described with reference to FIGS. 2 to 5 and 6 to 9, respectively, is performed by a processor executing corresponding software.

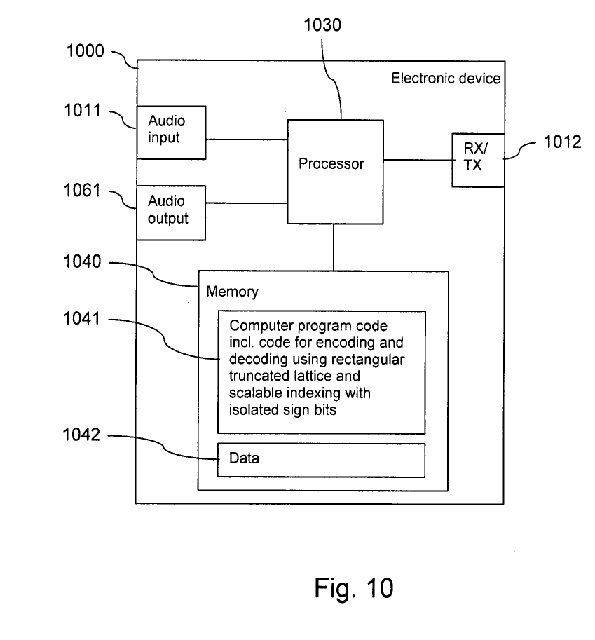

FIG. 10 is a schematic block diagram of an exemplary electronic device 1000, in which an audio coding using an indexing in accordance with the invention is implemented in software.

The electronic device 1000 can be for example a mobile phone. It comprises a processor 1030 and linked to this processor 1030 an audio input component 1011, an audio output component 1061, a transceiver (RX/TX) 1012 and a memory 1040. It is to be understood that the indicated connections can be realized via various other elements not shown.

The audio input component 1011 can be for instance a microphone or an interface to some audio source. The audio output component 1061 can be for instance a loudspeaker. The memory 1040 comprises a section 1041 for storing computer program code and a section 1042 for storing data. The stored computer program code comprises code for encoding audio signals using a rectangular truncated lattice and code for decoding audio signals using a rectangular truncated lattice. The processor 1030 is configured to execute available computer program code. As far as the available code is stored in the memory 1040, the processor 1030 may retrieve the code to this end from section 1041 of the memory 1040 whenever required. It is to be understood that various other computer program code is available for execution as well, like an operating program code and program code for various applications.

The stored encoding code or the processor 1030 in combination with the memory 1040 could be seen as an exemplary first and second apparatus according to the invention. The memory 1040 could also be seen as an exemplary computer program product according to the invention.

When a user selects a function of the electronic device 1000, which requires an encoding of an input audio signal, an application providing this function causes the processor 1030 to retrieve the encoding code from the memory 1040.

Audio signals received via the audio input component 1011 are then provided to the processor 1030—in the case of received analog audio signals after a conversion to digital audio signals, etc.

The processor 1030 executes the retrieved encoding code to encode the digital audio signal. The encoding may correspond to the encoding described above with reference to FIGS. 1 to 5. Alternatively, the encoding could be based on some other coding approach that uses a fixed or scalable indexing of a rectangular truncated lattice codevector based on separate terms for positions of non-zero components of the codevector and for the signs of the non-zero components of the codevector.

The encoded audio signal is either stored in the data storage portion 1042 of the memory 1040 for later use or transmitted by the transceiver 1012 to another electronic device.

The processor 1030 may further retrieve the decoding code from the memory 1040 and execute it to decode an encoded audio signal that is either received via the transceiver 1012 or retrieved from the data storage portion 1042 of the memory 1040. The decoding may correspond to the decoding described above with reference to FIGS. 1 and 6 to 9. Alternatively, the encoding could be based on some other coding approach that uses a fixed or scalable indexing of a rectangular truncated lattice codevector based on separate terms for positions of non-zero components of the codevector and for the signs of the non-zero components of the codevector.

The decoded digital audio signal may then be provided to the audio output component 1061. In case the audio output component 1061 comprises a loudspeaker, the decoded audio signal may for instance be presented to a user via the loudspeaker after a conversion into an analog audio signal. Alternatively, the decoded digital audio signal could be stored in the data storage portion 1042 of the memory 1040.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

What is claimed is:

1. A method comprising:
determining number and positions of non-zero components of a codevector, said codevector being associated to a point of an outer shell of a rectangular truncated lattice and representing quantized audio data;
determining signs of said non-zero components of said codevector; and
calculating an index for said codevector by combining at least a term representing said determined number of non-zero components, a term representing determined positions of non-zero components and a term representing determined signs of non-zero components.

2. The method according to claim 1,
wherein said codevector has a dimension of n,
wherein said at least one term representing said determined number S of non-zero components is given
$$offset 0 ( S ) = {\sum }_{i = n}^{S + 1} {2}^{i} ( \begin{matrix}n \\ i\end{matrix} ) ,$$
wherein said at least one term representing said determined position of non-zero components is given by I_{S}2^{S}, where Iₛ is a position index defining positions of non-zero components in the entire codevector;
wherein said at least one term representing signs of non-zero components is an index I_{B} of sign bits; and
wherein said index I is calculated as
I=offset0(S)+I_{S}2^{S}+I_{B}.

3. The method according to claim 1, said method further comprising:
determining a number of maximum valued components, in absolute values, of said codevector;
wherein determining positions of said non-zero components of said codevector comprises determining positions of maximum valued components of said codevector and determining positions of non maximum valued non-zero components of said codevector; and
wherein calculating said index for said codevector comprises combining at least a term representing said determined number of non-zero components, a term representing said determined number of maximum valued components, a term representing determined positions of maximum valued components, a term representing determined positions of non maximum valued non-zero components and a term representing determined signs of non-zero components.

4. The method according to claim 3,
wherein said codevector has a dimension of n,
wherein said at least one term representing said determined number S of non-zero components is given by
$$offset 0 ( S ) = {\sum }_{i = n}^{S + 1} {2}^{i} ( \begin{matrix}n \\ i\end{matrix} ) ( {3}^{i} - {2}^{i} ) ;$$
wherein said at least one term representing said determined number of maximum valued components is given by
$$offset 1 ( S , M ) = {2}^{S} ( \begin{matrix}n \\ S\end{matrix} ) {\sum }_{i = S}^{M + 1} ( \begin{matrix}S \\ i\end{matrix} ) ;$$
wherein said at least one term representing said determined positions of maximum valued components is given by
$${I}_{k} {2}^{S} ( \begin{matrix}n - M \\ S - M\end{matrix} ) ,$$
where Iₖ is a position index indicating the positions of maximum valued components relative to the entire codevector;
wherein said at least one term representing said determined positions of non maximum valued non-zero components is given by Iₚₒₛ_{_{—}}ₙₖ2^{S}, where Iₚₒₛ_{_{—}}ₙₖ is a position index indicating the positions of non maximum valued non-zero components relative to the entire codevector exclusive said maximum valued components;
wherein said at least one term representing said signs of non-zero components is an index I_{B} of sign bits; and
wherein said index I is calculated as
$$I = offset 0 ( S ) + offset 1 ( S , M ) + {I}_{k} {2}^{S} ( \begin{matrix}n - M \\ S - M\end{matrix} ) + {I}_{pos\_nk} {2}^{S} + {I}_{B} .$$

5. The method according to claim 3, further comprising:
determining values of non maximum valued non-zero components; and
calculating said index for said codevector by combining in addition at least a term representing determined values of non maximum valued non-zero components.

6. The method according to claim 5,
wherein said codevector has a dimension of n and a maximum absolute norm equal to K,
wherein said at least one term representing said determined number S of non-zero components is given by
$$offset 0 ( S ) = {\sum }_{i = n}^{S + 1} {2}^{i} ( \begin{matrix}n \\ i\end{matrix} ) ( {K}^{i} - {( K - 1 )}^{i} ) ;$$
wherein said at least one term representing said determined number of maximum valued components is given by
$$offset 1 ( S , M ) = {2}^{S} ( \begin{matrix}n \\ S\end{matrix} ) {\sum }_{i = S}^{M + 1} ( \begin{matrix}S \\ i\end{matrix} ) {( K - 1 )}^{S - i} ;$$
wherein said at least one term representing said determined positions of maximum valued components is given by
$${I}_{k} {2}^{S} ( \begin{matrix}n - M \\ S - M\end{matrix} ) {( K - 1 )}^{S - M} ,$$
where Iₖ is a position index indicating the positions of maximum valued components relative to the entire codevector;
wherein said at least one term representing said determined values of non-zero non maximum valued components is given by
$${I}_{nk} {2}^{S} ( \begin{matrix}n - M \\ S - M\end{matrix} ) ,$$
where Iₙₖ is an order index of non maximum valued non-zero components of said codevector;
wherein said at least one term representing said determined positions of non maximum valued non-zero components is given by Iₚₒₛ_{_{—}}ₙₖ2^{S}, where Iₚₒₛ_{_{—}}ₙₖ is a position index indicating the positions of non maximum valued non-zero components relative to the entire codevector exclusive said maximum valued components;
wherein said at least one term representing said signs of non-zero components is an index I_{B} of sign bits; and
wherein said index I is calculated as
$$I = offset 0 ( S ) + offset 1 ( S , M ) + {I}_{k} {2}^{S} ( \begin{matrix}n - M \\ S - M\end{matrix} ) {( K - 1 )}^{S - M} + {I}_{nk} {2}^{S} ( \begin{matrix}n - M \\ S - M\end{matrix} ) + {I}_{pos\_nk} {2}^{S} + {I}_{B} .$$

7. The method according to claim 1, further comprising selecting additional terms for use in said combining for calculating said index for said codevector depending on at least one predetermined criterion.

8. The method according to claim 7, wherein said at least one criterion comprises a current bitrate restriction for said index.

9. The method according to claim 1, further comprising converting an audio signal into codevectors that are associated to a respective point of an outer shell of a respective rectangular truncated lattice and determining an index for each of said codevectors.

10. A method comprising:
extracting from an index separate information on the number and positions of non-zero components of a codevector, and on signs of components of said codevector, said codevector being associated to a point of an outer shell of a rectangular truncated lattice and representing quantized audio data; and
assembling a codevector complying with said extracted information on number and positions of said non-zero components and on signs of said non-zero components.

11. The method according to claim 10, said method further comprising:
extracting from said index in addition separate information on a number of maximum valued components of said codevector;
wherein extracting information on positions of non-zero components from said index comprises extracting separate information on positions of said maximum valued components and information on positions of non maximum valued non-zero components; and
wherein assembling a codevector comprises assembling a codevector complying with said extracted information on a number of said non-zero components, on a number of maximum valued components, on positions of said maximum valued components, on positions of said non maximum valued non-zero components and on signs of said non-zero components.

12. The method according to claim 11, further comprising:
extracting from said index in addition separate information on values of non maximum valued non-zero components;
wherein assembling a codevector comprises assembling a codevector complying in addition with said extracted information on values of non maximum valued non-zero components.

13. The method according to claim 10, further comprising selecting information that is to be extracted from said index depending on at least one predetermined criterion.

14. The method according to claim 13, wherein said at least one criterion comprises a number of bits used for said index.

15. The method according to claim 10, further comprising converting assembled codevectors into an audio signal.

16. An apparatus comprising an indexation component,
said indexation component being configured to determine number and positions of non-zero components of a codevector, said codevector being associated to a point of an outer shell of a rectangular truncated lattice and representing quantized audio data;
said indexation component being configured to determine signs of said non-zero components of said codevector; and
said indexation component being configured to calculate an index for said codevector by combining at least a term representing said determined number of non-zero components, a term representing determined positions of non-zero components and a term representing determined signs of non-zero components.

17. The apparatus according to claim 16,
wherein said indexation component is further configured to determine a number of maximum valued components, in absolute values, of said codevector;
wherein said indexation component is configured to determine positions of said non-zero components of said codevector by determining positions of maximum valued components of said codevector and determining positions of non maximum valued non-zero components of said codevector; and
wherein said indexation component is further configured to calculate said index for said codevector by combining at least a term representing said determined number of non-zero components, a term representing said determined number of maximum valued components, a term representing determined positions of maximum valued components, a term representing determined positions of non maximum valued non-zero components and a term representing determined signs of non-zero components.

18. The apparatus according to claim 17,
wherein said indexation component is further configured to determine values of non maximum valued non-zero components; and
wherein said indexation component is configured to calculate said index for said codevector by combining in addition at least a term representing determined values of non maximum valued non-zero components.

19. The apparatus according to claim 16, wherein said indexation component is further configured to select additional terms for use in said combining for calculating said index for said codevector depending on at least one predetermined criterion.

20. The apparatus according to claim 19, wherein said at least one criterion comprises a current bitrate restriction for said index.

21. The apparatus according to claim 16, further comprising processing components configured to convert an audio signal into codevectors that are associated to a respective point of an outer shell of a respective rectangular truncated lattice, wherein said indexation component is configured to determine an index for each of said codevectors.

22. An electronic device comprising:
an apparatus according to claim 16; and
an audio input component.

23. An apparatus comprising an inverse indexation component,
said inverse indexation component being configured to extract from an index separate information on number and positions of non-zero components of a codevector and on signs of components of said codevector, said codevector being associated to a point of an outer shell of a rectangular truncated lattice and representing quantized audio data; and
said inverse indexation component being configured to assemble a codevector complying with said extracted information on number and positions of said non-zero components and on signs of said non-zero components.

24. The apparatus according to claim 23,
wherein said inverse indexation component is further configured to extract from said index in addition separate information on a number of maximum valued components of said codevector;
wherein said inverse indexation component is configured to extract information on positions of non-zero components from said index by extracting separate information on positions of said maximum valued components and information on positions of non maximum valued non-zero components; and
wherein said inverse indexation component is configured to assemble a codevector complying with said extracted information on a number of said non-zero components, on a number of maximum valued components, on positions of said maximum valued components, on positions of said non maximum valued non-zero components and on signs of said non-zero components.

25. The apparatus according to claim 24,
wherein said inverse indexation component is further configured to extract from said index in addition separate information on values of non maximum valued non-zero components; and
wherein said inverse indexation component is configured to assemble a codevector complying in addition with said extracted information on values of non maximum valued non-zero components.

26. The apparatus according to claim 23, wherein said inverse indexation component is further configured to select information that is to be extracted from said index depending on at least one predetermined criterion.

27. The apparatus according to claim 26, wherein said at least one criterion comprises a number of bits used for said index.

28. The apparatus according to claim 23, further comprising processing components configured to convert assembled codevectors into an audio signal.

29. An electronic device comprising:
an apparatus according to claim 23; and
an audio output component.

30. A system comprising:
an apparatus according to claim 16; and
an apparatus comprising an inverse indexation component, said inverse indexation component being configured to extract from an index separate information on number and positions of non-zero components of a codevector and on signs of components of said codevector, said codevector being associated to a point of an outer shell of a rectangular truncated lattice and representing quantized audio data; and
said inverse indexation component being configured to assemble a codevector complying with said extracted information on number and positions of said non-zero components and on signs of said non-zero components.

31. A computer program product in which a program code is stored in a computer readable medium, said program code realizing the method of claim 1 when executed by a processor.

32. A computer program product in which a program code is stored in a computer readable medium, said program code realizing the method of claim 10 when executed by a processor.

33. An apparatus comprising:
means for determining number and positions of non-zero components of a codevector, said codevector being associated to a point of an outer shell of a rectangular truncated lattice and representing quantized audio data;
means for determining signs of said non-zero components of said codevector; and
means for calculating an index for said codevector by combining at least a term representing determined number and positions of non-zero components and a term representing determined signs of non-zero components.

34. An apparatus comprising:
means for extracting from an index separate information on number and positions of non-zero components of a codevector and on signs of components of said codevector, said codevector being associated to a point of an outer shell of a rectangular truncated lattice and representing quantized audio data; and
means for assembling a codevector complying with said extracted information on number and positions of said non-zero components and on signs of said non-zero components.
